(19) United States
(12) Patent Application Publication
(10) Pub. No.: US 2008/0052262 A1
(43) Pub. Date: Feb. 28, 2008

(54) Method for personalized named entity recognition

(76) Inventors: Serhiy Kosinov, Geneva (CH); Igor Kozintsev, San Jose, CA (US); Marzia Polito, Burbank, CA (US); Carole Dulong, Saratoga, CA (US)

Correspondence Address: INTEL CORPORATION;c/o INTELLEVATE, LLC, P.O. BOX 52050, MINNEAPOLIS, MN, 55402, US

(21) Appl. No.: 11/508,579

(22) Filed: Aug. 22, 2006

(51) Int. Cl. G06F 17/30

(52) U.S. Cl. 707/1

(57) ABSTRACT

Personalized named entity recognition may be accomplished by parsing input text to determine a subset of the input text, generating a plurality of queries based at least in part on the subset of the input text, submitting the queries to a plurality of reference resources, processing responses to the queries and generating a vector based on the responses, and performing classification based at least in part on the vector and a set of model parameters to determine a likelihood as to which named entity category the input text belongs.

### BACKGROUND

1. Field

The present invention relates generally to named entity recognition and, more specifically, to personalized named entity recognition techniques for use in personal image and video database mining.

2. Description

Information extraction (IE) is a type of information retrieval processing whose goal is to automatically extract structured or semi-structured information from unstructured machine-readable documents. It is a sub-discipline of language engineering, a branch of computer science. It aims to apply methods and technologies from practical computer science such as compiler construction and artificial intelligence to the problem of processing unstructured textual data automatically, with the objective to extract structured knowledge in some domain. A typical application of IE is to scan a set of documents written in a natural language and populate a database with the information extracted. Current approaches to IE use natural language processing techniques that focus on very restricted domains.

A typical subtask of IE is called named entity recognition (NER). An entity is an object of interest. Named entity recognition refers to locating and classifying atomic elements in text into pre-defined categories such as names of people and organizations, place names, events, temporal expressions, and certain types of numerical expressions. NER systems have been created that use linguistic grammar-based techniques as well as statistical models. Hand-crafted grammar-based systems typically obtain better results, but at the cost of months of work by experienced linguists. Statistical NER systems require much training data, but can be ported to other languages more rapidly and require less work overall.

NER has been applied to the problem of managing databases of digital images and video. Existing solutions for multimedia management target mostly large web-based databases and rely on extensive metadata generation to aid in search, browsing, and retrieval of multimedia data. Personal multimedia databases, on the other hand, have very limited metadata generated by the end users themselves. This sparse annotation of images and video provides a lack of context for successful performance of NER using known techniques.

### BRIEF DESCRIPTION OF THE DRAWINGS

The features and advantages of the present invention will become apparent from the following detailed description of the present invention in which:

FIG. 1 is a diagram of a sample user interface for named entity recognition processing according to an embodiment of the present invention;

FIG. 2 is a diagram of a personal multimedia application coupled to a named entity recognition system according to an embodiment of the present invention;

FIG. 3 is a flow diagram illustrating named entity recognition processing according to an embodiment of the present invention;

FIG. 4 is an example of input text being parsed to find the head noun according to an embodiment of the present invention;

FIG. 5 is a sample table of reference resources used in a named entity recognition system according to an embodiment of the present invention;

FIG. 6 is an example of converting textual responses from a reference resource into a vector according to an embodiment of the present invention; and

FIG. 7 is a diagram of a named entity recognition system according to an embodiment of the present invention.

### DETAILED DESCRIPTION

Embodiments of the present invention assist in the generation of hierarchical semantic databases to augment multimedia data collections and their associated limited semantic tags by automatically determining categories for named entities. In some applications such as personal digital image or video collections, named entities (e.g., John, Berlin, Peter's 21^{st} birthday party) constitute on average more than two thirds of the succinct tags entered by the user to annotate individual items or portions of the user's collection. This is a natural confirmation of the fact that a typical digital multimedia collection is personal, hence the emphasis is on individual-specific semantic content (e.g., family, friends, vacations, events, etc.). Therefore, a solution to the named entity recognition problem is very useful for personal multimedia databases.

Embodiments of the present invention comprise a method for automatic grouping of the named entities present in personal multimedia databases into a set of basic ontologies covering general, universally acceptable categories, such as people, places, and events. An ontology is the hierarchical structuring of knowledge about things by subcategorizing them according to their essential (or at least relevant and/or cognitive) qualities. The present approach is based on a fusion of semantic clues obtained from multiple heterogeneous online and offline reference resources, given a named entity as an input parameter, to automatically determine the likelihood that the named entity being processed belongs to a particular category. In one embodiment, information from on-line reference resources may be cached locally on the user's processing system to achieve real-time performance without loss of accuracy. Supervised machine learning methods may be used to design a set of classifiers for named entities and to fuse them together to determine the general category for the named entity being processed. In one embodiment, an interactive learning algorithm may then be applied that will allow the user to extend, modify, and adjust the automatically generated categories.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

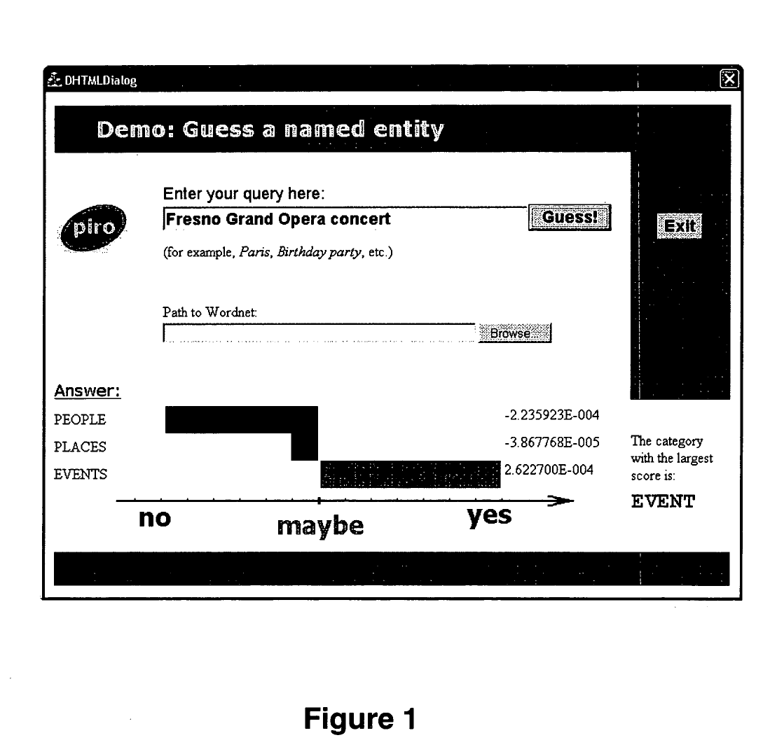

FIG. 1 is a diagram of a sample user interface for named entity recognition processing according to an embodiment of the present invention. In this example, a user may type in a phrase (such as “Fresno Grand Opera Concert”) in a graphical user interface as shown. The named entity recognition (NER) system of embodiments of the present invention will take the input text, perform named entity recognition processing, and output a number representing the likelihood that the input text belongs to a category of named entities. The NER system may output a number for each of a plurality of categories of named entities. For example, the named entity recognition system may output one number indicating the likelihood that the input text belongs to the category of people, another number indicating the likelihood that the input text belongs to the category of places, and yet another number indicating the likelihood that the input text belongs to the category of events. If the number is a small negative number, in one embodiment this indicates that the likelihood that the input text belongs to the category is very low (for example, the number −2.235923×10⁻⁴ for the people category for the sample input text of FIG. 1). If the number is a large positive number, in one embodiment this indicates that the likelihood that the input text belongs to the category is very high (for example, the number 2.622700×10⁻⁴ for the events category for the sample input text of FIG. 1). The most likely category may be displayed to the user. Although only the categories of people, places, and events is shown in the example of FIG. 1, other categories may also be used. In essence, the named entity hierarchy is extendable to other categories. In the example user interface of FIG. 1, horizontal colored bars are used as a visual representation of the numbers and outcomes (e.g., yes, no or maybe), but in other implementations, other indications may be used without departing from the scope of the present invention.

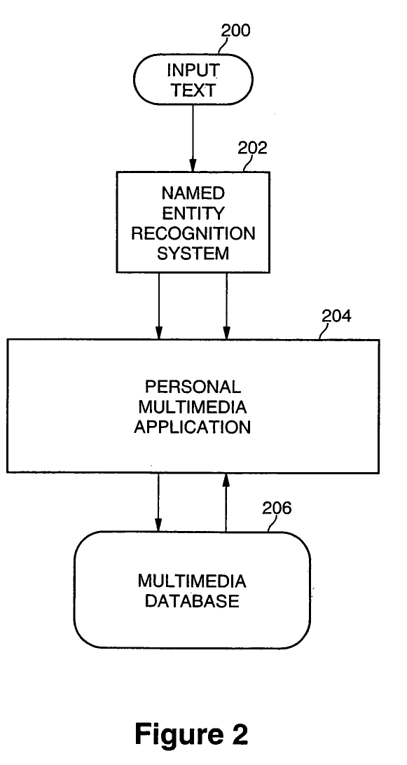

When used in conjunction with a personal multimedia application (used to store, retrieve, and render multimedia data), the entering of the phrase by the user (or extracting tags or other text associated with the data) may be a direction to the application to find all multimedia data in a user's collection that is associated with the input text. By determining which category the input text relates to, the application may be able to more quickly and accurately find relevant multimedia data items (e.g., images, videos, songs, other sound files, etc.) in the collection for the user. FIG. 2 is a diagram illustrating how the named entity recognition system of embodiments of the present invention may be coupled with a personal multimedia application. Input text 200 may be input to NER system 202. The NER system automatically determines a most likely category corresponding to the input text. The input text and the category may be input to personal multimedia application 204. The personal multimedia application uses the input text, automatically determined category, and optionally, other information, to efficiently search multimedia database 206 corresponding to the user's query. In the embodiment shown in FIG. 2, the NER system is shown separate from the personal multimedia application and the multimedia database, but in other embodiments any combination of the components may be integral.

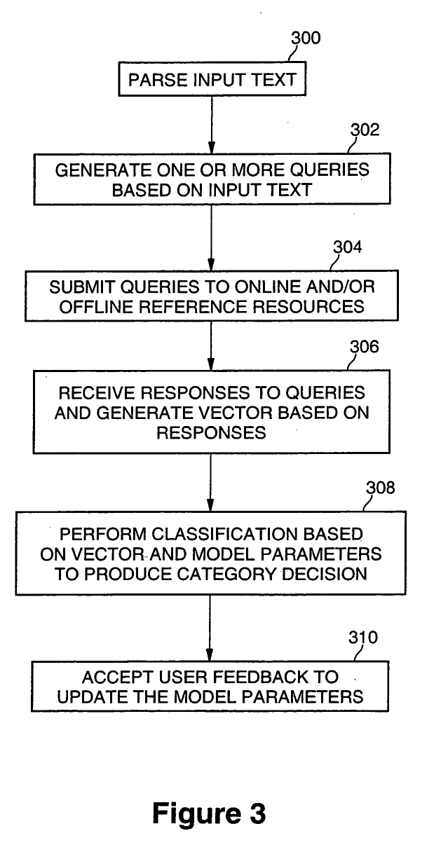

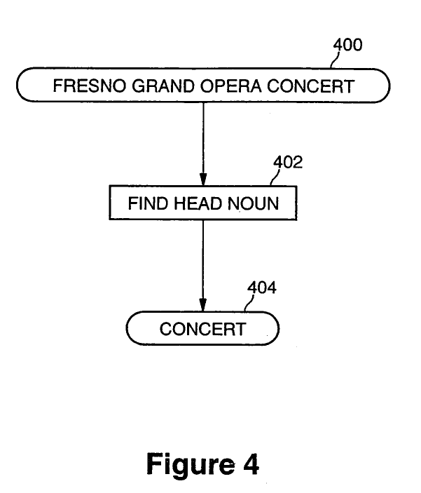

FIG. 3 is a flow diagram illustrating named entity recognition processing according to an embodiment of the present invention. At block 300, the input text may be parsed. The input text may be entered by the user freely and unformatted via a user interface (e.g., via a keyboard, mouse, or other input device), extracted from a file name, taken from a caption, tag, or metatag of a multimedia file (such as an image or video data file), obtained via known automatic speech recognition methods from an audio component of multimedia data, or obtained by any other means. In one embodiment, parsing comprises breaking the input text into separate words and finding the head noun of the input text. FIG. 4 is an example of input text being parsed to find the head noun according to an embodiment of the present invention. The NER system determines that the word “Concert” in this example is the head noun of the input text phrase “Fresno Grand Opera Concert.” The parsing of the input text is context independent.

At block 302, one or more queries may be generated based on the input text (i.e., based on the head noun in one embodiment). The queries may be generated to conform to a known syntax for queries to a particular reference resource, whether online or offline. For example, a query may be in hyper text transport protocol (HTTP) format for making a query to a website. In one embodiment, many queries may be generated, with each query being sent to a specific web site.

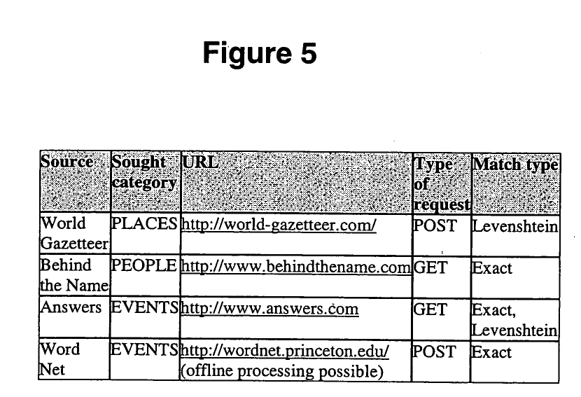

At block 304, the queries may be submitted to a plurality of online and/or offline heterogeneous reference resources. A reference resource comprises a website, database, application program, or other information repository that can accept a query for information and return an appropriate response. In one embodiment, many heterogeneous reference resources may be used, such as a publicly available semantic lexicon application program called “WordNet” (publicly available from Princeton University) which may be stored offline (i.e., locally available), a computerized dictionary, almanac, gazette/gazetteer, or name database, and online web sites such as “Behind the Name,” “Answers,” and “World Gazetteer.” Many other reference resources, both online and offline, may be used. In one embodiment, the reference resource may be cached locally to provide for fast access. FIG. 5 is a sample table of reference resources used in a named entity recognition system according to an embodiment of the present invention. The sample table shows four reference resources, but any number of reference resources may be queried by any number of queries to assist in determining the category corresponding to the named entity in the input text. In one embodiment, each reference resource returns a human readable text string in response to a query. In one embodiment, the NER system determines if the response to the query indicates an exact match to a category or a Levenshtein match or a combination of the two. According to the National Institute of Standards and Technology (NIST), a Levenshtein distance is the smallest number of insertions, deletions, and substitutions required to change one string or tree into another.

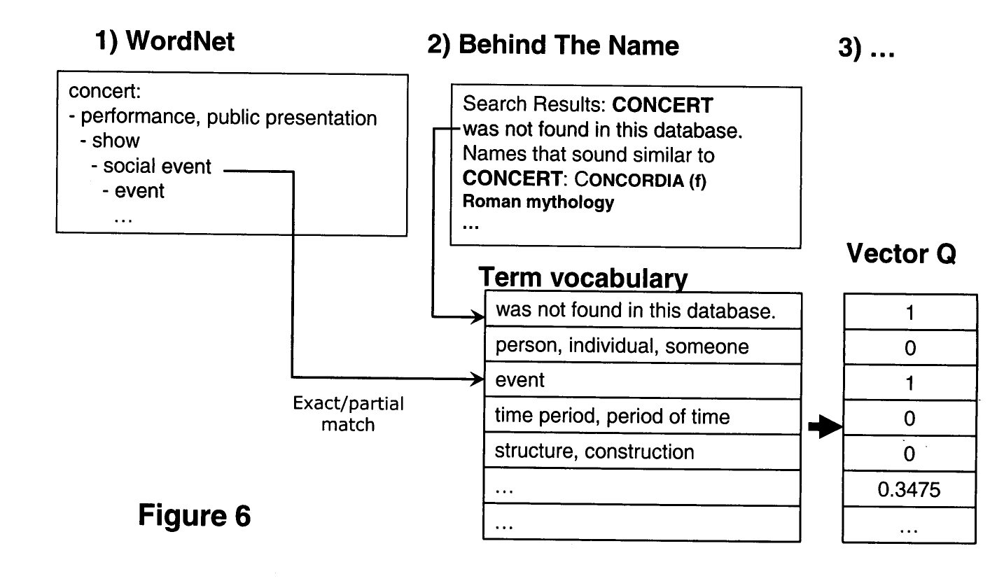

At block 306, the responses to the queries may be received, and a vector may be generated based at least in part on the responses. The textual responses may be converted to a vector of multiple numbers. The resulting vector is a numeric representation of the query results. FIG. 6 is an example of converting textual responses from a reference resource into a vector according to an embodiment of the present invention. In this example, the detected head noun “concert” is included in a query to a first reference resource called “WordNet.” The WordNet application returns the test shown in the box that states that a concert is a performance, public presentation, show, social event, event, and so on. The word “event” matches a term in the term vocabulary table as shown. Since the match is exact, the vector element corresponding to the term vocabulary table item may be set to “1” to indicate an exact match. Other vector elements may be set to “0” indicating no match. The term vocabulary table may be populated with terms to assist in determining the category. The detected head noun may also be sent in a query to another reference resource, such as the “Behind the Name” website. This web site returns data that indicates that the head noun was not found in the database (meaning the head noun is probably not a person's name). The words “was not found in this database” matches a term in the term vocabulary table as shown. Thus, the vector element may be set to “1” indicating the exact match. Processing of the query responses may be repeated, thereby building the vector that represents all of the responses. If a match is determined to be partial, a number between 0 and 1 may be entered into a vector element. Thus, processing at block 306 combines a character-level inexact similarity model with exact lexical matching to determine the numeric value stored in the vector for a query response.

At block 308, classification may be performed based at least in part on the vector of numbers generated at block 306, and a set of model parameters to produce a category decision. The model parameters comprise support vectors and associated weights. The classifier may be represented by several sets of weights (one per category), and the predictive estimate for a given cateory is computed as a linear combination of the vector representation of the query response and classifier weights. The model parameters may be used by the classifier to make a category decision. The model parameters may be set up during a training phase for the classifier. The NER system may use sample queries to the user to adjust the model parameters. In one embodiment, the classifier comprises a known support vector machine-based classifier that takes a linear combination of the vector quantities constructed at block 306 and the model parameters to produce a positive or negative number indicating the likelihood that the input text matches a specific category (i.e., people, place, event, etc.). In one embodiment, there may be a separate classifier for each category. In another embodiment, the classifier may be configured to perform multiple classification. Each category decision may be displayed to the user, used to search the personal multimedia collection, or for other purposes.

At block 310, user feedback may be accepted to update the model parameters in a feedback/adaptation loop. For example, during a training phase or thereafter, a user may assert that a query belongs to a certain category. Updating the model parameters may result in better classification decisions.

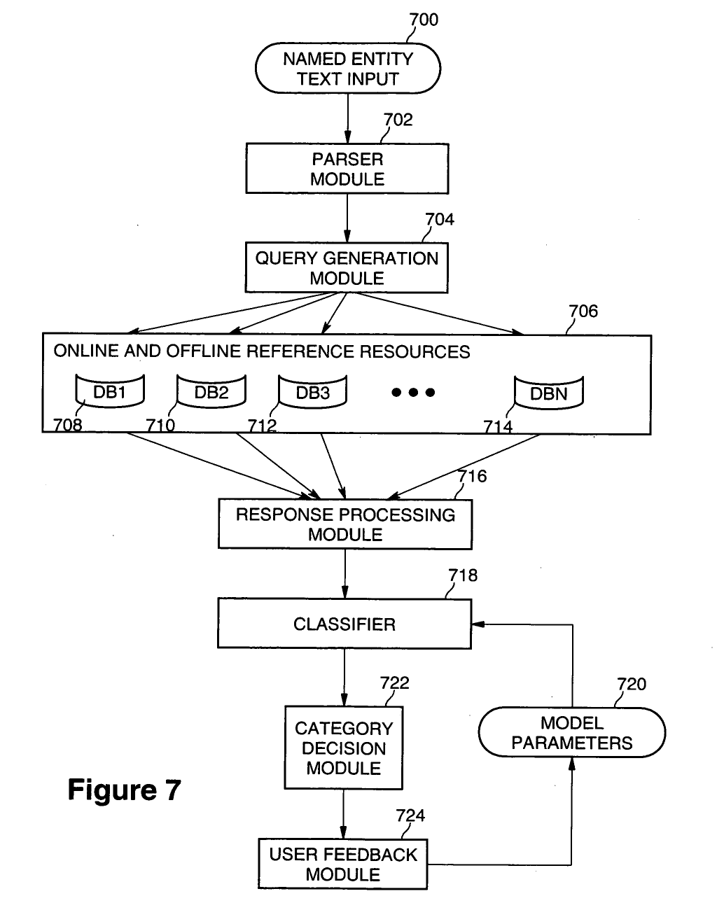

FIG. 7 is a diagram of a named entity recognition system according to an embodiment of the present invention. In one embodiment, named entity text input 700 may be received and parsed by parser module 702. The parser module identifies the head noun of the input text. The parser module passes the head noun to query generation module 704. The query generation module generates a plurality of queries to gather information about the head noun. The queries may be sent to a plurality of heterogeneous online and offline reference resources 706. These resources are represented as a plurality of databases DB1 708, DB2 710, DB3 712, . . . DBN 714, in FIG. 7, although the resources may be web sites, application programs, databases, and so on. Responses to the queries may be received and processed by response processing module 716. The response processing module performs a text to numeric score conversion of the responses to produce a vector. The vector may then be passed to classifier 718. The classifier generates numeric scores for each category by combining scores in the vector from individual online and offline reference resources. The classifier uses the model parameters 720 to perform the classification. Category decision module 722 then assigns a likely category to the input text string based on the classifier scores. The category may then be used for display to the user or for other data mining purposes. User feedback module 724 adapts the model parameters if the user indicates a category for a particular input string. In one embodiment, this may be performed during a training phase of the classifier.

Named entity recognition is usually considered as a problem of determining the semantic label of a particular word representing a named entity in the presence of some other words or context. Prior art solutions rely heavily on such contextual features as punctuation, properties of the words that precede and/or follow the word in question, parsed syntactic information from the whole sentence, etc. However, in personal image and video database indexing, classification and retrieval, the above context information is largely unavailable due to the sparse and succinct nature of supplied annotation.

Embodiments of the present invention recognize this fact and strive to focus primarily on the word (i.e., head noun) itself instead of its context. Context independence is necessary for usage scenarios having sparse annotation and possibly real-time input typed by a user, such as in a personal multimedia collection application. In this scenario, embodiments of the present invention go beyond a straightforward choice of dictionary-based processing by aggregating information synchronously and asynchronously from diverse information sources and using different processing techniques. In at least one embodiment, exact lexical matching may be combined with approximate similarity models (e.g., Levenshtein distance) applied to the data gathered from heterogeneous sources such as dictionaries, gazetteers and semantic lexicons. Subsequently, such data is processed with a supervised machine learning technique which allows the user to extend, adapt and modify the semantics of the personalized annotation tags of items in a personal multimedia collection and the structure of relationships among them. The latter represents a personalized semantic hierarchy of named entities that may be coupled with other known content-based retrieval methods to provide a more intelligent and natural way to organize, access and interact with personal digital media collections. Embodiments of the present invention may be used for extensible named entity hierarchy processing for enabling real-time multimedia mining applications for personal multimedia databases.

Although the operations described herein may be described as a sequential process, some of the operations may in fact be performed in parallel or concurrently. In addition, in some embodiments the order of the operations may be rearranged.

The techniques described herein for the named entity recognition system and personal multimedia application are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a tangible machine accessible medium having stored thereon instructions that may be used to program a processing system or other electronic device to perform the methods. The term “machine accessible medium” used herein shall include any medium that is capable of storing or encoding a sequence of instructions for execution by a machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

What is claimed is:

1. A method of personalized named entity recognition comprising:
parsing input text to determine a subset of the input text;
generating a plurality of queries based at least in part on the subset of the input text;
submitting the queries to a plurality of reference resources;
processing responses to the queries and generating a vector based on the responses; and
performing classification based at least in part on the vector and a set of model parameters to determine a likelihood as to which named entity category the input text belongs.

2. The method of claim 1, wherein the subset comprises a head noun of the input text.

3. The method of claim 1, wherein at least one of the reference resources comprises an on-line web site.

4. The method of claim 1, wherein at least one of the reference resources comprises an offline application program.

5. The method of claim 1, wherein the vector comprises a plurality of numeric values, each numeric value representing the likelihood that the subset of the input text corresponds to a term in a term vocabulary data structure.

6. The method of claim 1, wherein the classification performed comprises support vector machine-based classification.

7. The method of claim 1, further comprising accepting user feedback to update the set of model parameters.

8. The method of claim 1, wherein the named entity categories in a named entity hierarchy comprise at least people names, place names, and event names, the named entity hierarchy being extendable to other categories.

9. The method of claim 3, wherein the reference resources comprise one or more dictionaries, directories, semantic lexicons, and gazetteers, and the responses from the reference resources are represented as numeric values in the vector.

10. The method of claim 1, wherein parsing is performed independent of context of the input text.

11. The method of claim 5, wherein processing responses to the queries comprises combining a character-level inexact similarity model with exact lexical matching to determine the numeric value stored in the vector for a query.

12. The method of claim 1, wherein the input text comprises one of at least a portion of a filename of a multimedia file and a tag associated with the multimedia file.

13. An article comprising: a tangible machine accessible medium containing instructions, which when executed, result in personalized named entity recognition by
parsing input text to determine a subset of the input text;
generating a plurality of queries based at least in part on the subset of the input text;
submitting the queries to a plurality of reference resources;
processing responses to the queries and generating a vector based on the responses; and
performing classification based at least in part on the vector and a set of model parameters to determine a likelihood as to which named entity category the input text belongs.

14. The article of claim 13, wherein the vector comprises a plurality of numeric values, each numeric value representing the likelihood that the subset of the input text corresponds to a term in a term vocabulary data structure.

15. The article of claim 13, further comprising instructions to accept user feedback to update the set of model parameters.

16. The article of claim 13, wherein the named entity categories in a named entity hierarchy comprise at least people names, place names, and event names, the named entity hierarchy being extendable to other categories.

17. The article of claim 13, wherein the reference resources comprise one or more of dictionaries, directories, semantic lexicons, and gazetteers, and the responses from the reference resources are represented as numeric values in the vector.

18. The article of claim 13, wherein parsing the input text is performed independent of context of the input text.

19. The article of claim 13, wherein processing responses to the queries comprises combining a character-level inexact similarity model with exact lexical matching to determine the numeric value stored in the vector for a query.

20. A personalized named entity recognition system comprising:
a parser module to parse input text to determine a subset of the input text;
a query generation module to generate a plurality of queries based at least in part on the subset of the input text, and to submit the queries to a plurality of reference resources;
a response processing module to process responses to the queries and generating a vector based on the responses;
a classifier to perform classification based at least in part on the vector and a set of model parameters; and
a category decision module to determine a likelihood as to which named entity category the input text belongs based at least in part on the classification.

21. The personalized named entity recognition system of claim 20, further comprising a user feedback module to update the set of model parameters during classifier training.

22. The personalized named entity recognition system of claim 20, wherein the subset comprises a head noun of the input text.

23. The personalized named entity recognition system of claim 20, wherein the vector comprises a plurality of numeric values, each numeric value representing the likelihood that the subset of the input text corresponds to a term in a term vocabulary data structure.

24. The personalized named entity recognition system of claim 20, wherein the classification module comprises a support vector machine-based classifier.

25. The personalized named entity recognition system of claim 20, wherein the named entity categories in a named entity hierarchy comprise at least people names, place names, and event names, the named entity hierarchy being extendable to other categories.

26. The personalized named entity recognition system of claim 20, wherein the reference resources comprise a plurality of at least one of online and offline resources, including one or more of dictionaries, directories, semantic lexicons, and gazetteers, and the responses from the reference resources are represented as numeric values in the vector.

27. The personalized named entity recognition system of claim 20, wherein the parsing is performed independent of context of the input text.

28. The personalized named entity recognition system of claim 20, wherein the response processing module is adapted to combine a character-level inexact similarity model with exact lexical matching to determine the numeric value stored in the vector for a query.

29. The personalized named entity recognition system of claim 20, wherein the input text comprise one of at least a portion of a filename of a multimedia file and a tag associated with the multimedia file.

30. A system comprising:
a multimedia database to store a plurality of multimedia files;
a personal multimedia application to access the multimedia files; and
a named entity recognition system coupled to the personal multimedia application, the named entity recognition system comprising
a parser module to parse input text to determine a subset of the input text;
a query generation module to generate a plurality of queries based at least in part on the subset of the input text, and to submit the queries to a plurality of reference resources;
a response processing module to process responses to the queries and generating a vector based on the responses;
a classifier to perform classification based at least in part on the vector and a set of model parameters; and
a category decision module to determine a likelihood as to which named entity category the input text belongs based at least in part on the classification.

31. The system of claim 30, wherein the personal multimedia application is adapted to search for one or more multimedia files in the multimedia database based at least in part on the named entity category determined by the category decision module.

32. The system of claim 30, wherein the reference resources comprise one or more dictionaries, directories, semantic lexicons, and gazetteers, and the responses from the reference resources are represented as numeric values in the vector.

33. The system of claim 30, wherein the parser module is adapted to parse the input text independent of context of the input text.

34. The system of claim 30, wherein the response processing module is adapted to combine a character-level inexact similarity model with exact lexical matching to determine the numeric value stored in the vector for a query.

35. The system of claim 30, wherein the input text comprises one of at least a portion of a filename of a multimedia file and a tag associated with the multimedia file.

36. The system of claim 30, wherein the named entity categories in a named entity hierarchy comprise at least people names, place names, and event names, the named entity hierarchy being extendable to other categories.
